(19) United States
(12) Patent Application Publication
(10) Pub. No.: US 2011/0112988 A1
(43) Pub. Date: May 12, 2011

(54) PORTABLE RADIO COMMUNICATION APPARATUS AND METHOD OF USE

(76) Inventors: William W. Baker, Hudsonville, MI (US); Geoffrey M. Penna, Hudsonville, MI (US)

(21) Appl. No.: 12/616,852

(22) Filed: Nov. 12, 2009

(51) Int. Cl. G06Q 90/00; H04H 20/49

(52) U.S. Cl. 705/500; 381/16

(57) ABSTRACT

A portable communication apparatus and method includes a portable AM transmitter assembly and antenna operably connected for broadcasting an AM signal to standard automobile radio receiver, such as on a travel information station frequency of 1610 KHz. The system is particularly constructed for mobility, durability, simplicity and ease of use, making it well adapted for use in emergency situations as well as for the broadcast of general community or travelers information at fixed or temporary locations during nonemergency times. For example, the entire present assembly 20 can be constructed with a total weight of less than about 130 lbs, allowing it to be easily moved by individuals and by low-weight-capable small capacity vehicles such as planes or boats or pick-up trucks. By this method, persons riding within vehicles who are monitoring the radio signal can be given instructions, including real-time instructions, concerning how to receive medical attention while remaining in their vehicles and/or how to avoid or take action in any number of emergency situations.

### BACKGROUND OF THE INVENTION

The present invention relates to portable radio communication apparatus and methods of use, and more particularly relates to a FCC license-able portable radio broadcast system that operates in the commercial AM radio band, 540-1700 KHz, as well as on 530 KHz, particularly constructed for mobility, durability, simplicity and ease of use, making it well adapted for use in emergency situations as well as for the broadcast of general community or travelers information at fixed or temporary locations during nonemergency times.

Communities must deal with a variety of different situations, including public events involving large numbers of people (e.g., concerts, shows, sporting events, etc.), construction and traffic situations (e.g., road and bridge construction), emergency situations (e.g., accidents, aftermath of storms, terrorist threats, etc.), and community health and medical situations (e.g., an H1N1 flu epidemic). Each of these situations require communication systems that can be temporarily put in place quickly for providing information about the particular situation to citizens via a device that is commonly possessed by these persons, in this application, a standard radio receiver. Additionally, community organizations and entities are under tremendous budget constraints and financial pressures, such that they cannot afford expensive, complex equipment, nor extensive training to operate such equipment.

Systems do exist that could potentially be used in these applications which employ FM radio signals and broadcast in the commercial FM band. However, while FM radio communication systems tend to be smaller in size and potentially more portable than AM systems, there are problems associated with FM systems. For example, the FM band is crowded, and acceptable frequencies are limited. Neither of the two FM technologies available from the FCC are adequate for the application. Also, unlicensed FM (available under FCC Part 15) is restricted in its range to 30 meters whereas the range of the proposed AM system is up to 5 miles. Licensed FM (Lower Power FM/LPFM) has range of up to 5 miles but is not available at this time from the FCC. Also, Lower Power FM (LPFM) is not practical for emergency services as its license authorization has requirements that would not meet the needs of emergency managers, including the requirement for fulltime, fixed-point operation only.

Other systems exist that do use AM radio signals and broadcast in the commercial AM band and are portable in nature. However, they are much larger in size, in the form of a towable trailer, and therefore are less portable than the proposed AM system which can be moved by hand by individuals and can be placed in any conveyance (e.g. automobile or airplane). Also, such systems do not possess the unique message database or message transfer abilities of the proposed solution.

### SUMMARY OF THE INVENTION

In one aspect of the present invention, a manually-movable portable system for giving community emergency information, as well as general travelers information, comprises a portable wheelable cabinet with a handle for manual transport to sites of use. A portable transmitter is housed in the cabinet and adapted to broadcast radio signals that can be received by a standard radio receiver in a passenger vehicle. A portable antenna is operably connected to the transmitter. A control circuit is connected to the transmitter, the control circuit including externally-accessible controls on at least one side of the cabinet and a digital audio file player for providing audio to the transmitter. A database of pre-recorded, selectable, messages is provided that can be accessed and selectively sent to the transmitter for broadcasting by the digital audio file player. A microphone is provided for receiving a live spoken message and is operably connected to the control circuit. The controls include a switch for switching between the pre-recorded messages and the microphone, whereby the system can be operated to transmit any one of the pre-recorded selectable messages as well as to transmit a specific real-time spoken instruction to passengers of the passenger vehicles by an operator who may be watching the passenger vehicle when the passenger vehicle enters a critical space.

In another aspect of the present invention, a method of giving community emergency information, comprises steps of providing a portable transmitter system and portable antenna system adapted to communicate to standard radio receivers within passenger vehicles, transmitting selected pre-recorded messages on the transmitter to communicate directly with passengers in the passenger vehicles, the pre-recorded messages including information about particular assistance sites to drive to for help with particular emergencies, watching the passenger vehicles as the passenger vehicles arrive at a particular assistance site, and switching to provide a live instruction to passengers in the passenger vehicles to control activity of the passengers and/or to control a flow of the passenger vehicles at the particular assistance site.

In another aspect of the present invention, a method of coordinating community emergency health treatment, comprises steps of providing a portable transmitter and portable antenna adapted to communicate to standard radio receivers within passenger vehicles, and transmitting selected messages on the transmitter to communicate directly with passengers in the passenger vehicles, the messages including instructions to the passengers asking for the passengers to extend their arm from a vehicle window for inspection and/or treatment as the vehicle passes one or more points of medical information-gathering, diagnosis and treatment. By this method, health emergencies, such as swine flu and other contagious epidemics, can be safely handled while still providing mass medical treatment in an efficient manner.

In another aspect of the present invention, a method of coordinating community emergency health treatment, comprises steps of providing a portable transmitter and portable antenna adapted to communicate to standard radio receivers within passenger vehicles, and transmitting selected messages on the transmitter to communicate directly with passengers in the passenger vehicles, the messages including instructions to the passengers asking for the passengers to follow specific procedures in order to obtain treatment or testing while the vehicle is in listening rage of the transmitter.

In another aspect of the present invention, a method for giving community emergency information, comprises steps of providing a plurality of at least three hand-portable cabinets each with a handle for manual transport to sites of use, a portable transmitter system housed in the cabinet and adapted to broadcast radio signals that can be received by a standard radio receiver in a passenger vehicle, and a portable antenna system adapted to operably connect to the transmitter system; the cabinets each further including a control circuit connected to the transmitter, the control circuit including controls on an outside of the cabinet and a digital audio file player for providing audio to the transmitter, a database of pre-recorded selectable messages that can be accessed and selectively sent to the transmitter for broadcasting by the digital audio file player, a microphone for receiving a live spoken message operably connected to the control circuit, and a switch for switching from transmitting the pre-recorded messages to the microphone. The method further includes placing the at least three hand-portable cabinets and associated antennas in a truck, dropping off the at least three hand-portable cabinets at different strategic locations, activating each of the transmitters to transmit a selected message, and manually operating at least one of the transmitters to periodically transmit a specific real-time spoken instruction to passengers of the passenger vehicles by an operator watching the passenger vehicle when the passenger vehicle enters a critical space.

An object of the present invention is to provide a hand-portable system operating in the standard AM band—540-1700 KHz, as well as on 530 KHz, a frequency exclusive to the TIS service.

An object of the present invention is to provide a system that can be set up and turned on quickly, and made fully operational quickly, such as within 5 minutes.

An object of the present invention is to provide an entire system that weighs less than 130 lbs (the heaviest component being the rolling portable case—potentially weighing as little as 68 pounds), such that it can be moved by hand by a single person without the need for special trailers or transporters, yet that has a weight that does not cause lifting/safety issues.

An object of the present invention is to provide a communication system in finished form that can be shipped by common carrier to different locations, unpackaged and set up for immediate use without assembly, including shipment on light “bush” airplanes, boats and other light-capacity vehicles.

An object of the present invention is to provide a system that, due to its compact size, it may be loaded into the back of a vehicle or carried onto an airplane or small boat for easy transport.

An object of the present invention is to provide multiple radio stations that, due to their compact size and low weight, can be distributed to various locations in one vehicle, sequentially (as well as the portable signs that announce the signal frequencies).

An object of the present invention is to provide a one-piece lightweight portable antenna stand (with integral antenna mounts, lightning arrestor, portable ground plane, and ground bus) designed to operate in high wind conditions. The stand with attached antenna and ground plane may be placed on a rooftop or on the ground, and the folding legs weighted with sand bags (provided) for stability. The legs of the stand can become part of the ground plane of the antenna system. The horizontal groundplane is designed such that it may be temporary installed on the surface of the ground, rooftop, paved street or parking lot without the requirement for burial under the surface of the ground beneath it, and may be deployed and stowed in less than one Minute by a single operator.

An object of the present invention is to provide a system that allows the transmitter and antenna system to be installed at locations separated by as much as 100 feet from the transmitter to accommodate the variations in broadcasting locations. For example, the present system allows an operator to keep the transmitter/electronics case in the building, and place the antenna atop the building on the roof. Also, an operator can operate the transmitter from the back of his/her van and locate the antenna on an optimum broadcast point nearby, such as a high point of ground or clear area such as a parking lot.

An object of the present invention is to provide a portable case having an inline watt meter for confirming transmitter operation and diagnosing antenna tuning and performance as well as for providing a dummy load for determining coaxial cable connection integrity.

An object of the present invention is to provide a system that can broadcast live or broadcast recorded messages to listeners or motorists, including listeners who the broadcaster can see, which thus allows the live broadcaster to tailor the messages to the person being watched.

An object of the present invention is to provide a communication system where messages may be uploaded as digital audio files via Ethernet protocol or USB ports located within the electronics case. Optionally, the messages may also be uploaded via dial-up telephone line, cellular telephone and/or two-way radio transceiver.

An object of the present invention is to provide a communication system that is sufficiently durable and rated for continuous duty such that at the option of the operator, it can be operated full-time at a fixed location if portability is not required.

An object of the present invention is to take advantage of the reduction in size and weight of the transmitter and the emergence digital audio file players such as those which operate by the use of .mp3 or similar electronic audio files. This has made it possible to put such players in humanly transported cases. Advances in the portable case market have made them a reasonable host for the specific electronics we use: rack mountable with shock mounts; wheels and handle for rolling transport.

An object of the present invention is to provide a communication system and method that can be used in unique emergency and medical applications, such as:
Directing motorists to which hospital to visit based on their condition;
To inform motorists regarding directions and procedures during mass inoculation;
Based on real-time instruction given by the system operator broadcasting live, a motorist can maneuver to a particular location in a hospital parking lot, allowing a patient to receive treatment or testing while remaining in their vehicle (so that they do not need to enter the hospital and/or for increased patient-flow efficiency and/or for improved patient and hospital personnel isolation).
Prior to, during or in the aftermath of disasters, to inform the public regarding emergency services, evacuation routes or official announcements or public safety orders.
In association with public events, to inform the public of traffic status, directions, how to exit the event efficiently upon its conclusion or should the event be terminated due to an emergency such as weather or a emergency of a human source.

An object of the present invention is that this system may be licensed under FCC rules (90.242) Travelers Information Service (TIS) which affords the following unique points.
TIS is the only service available thru the FCC that allows for broadcast on 0.53 MHz AM (530 Khz AM).
It is the only type of FCC licensed service by which government entity or medical agency can broadcast on the standard AM broadcast band 540-1700 KHz.
The TIS License is protected to 15 km radius against use by other on-channel TIS operators, and has a license term of 10 years.
It may be licensed in either a fixed-point and/or within a territory (or both) and therefore has the capability to allow the licensee to move the radio station to reach the required geography/audience

Because of its utility to communities in emergencies, grant funding from the US Department of Homeland Security is often obtained for the purchase of TIS stations.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a schematic perspective view showing an operator broadcasting through the present apparatus/system to a motorist, giving the motorist directions concerning in-vehicle medical treatment available to large numbers of people, such as a flu shot.

FIG. 2 is block circuit diagram and FIG. 2A is a more detailed drawing showing physical details of individual components in FIG. 2.

FIG. 3 is a schematic perspective view showing transport of multiple systems/apparatus to multiple locations by a single pickup truck or other vehicle, such as plane, helicopter, boat, snowmobile, and the like.

### DETAILED DESCRIPTION OF PREFERRED EMBODIMENT

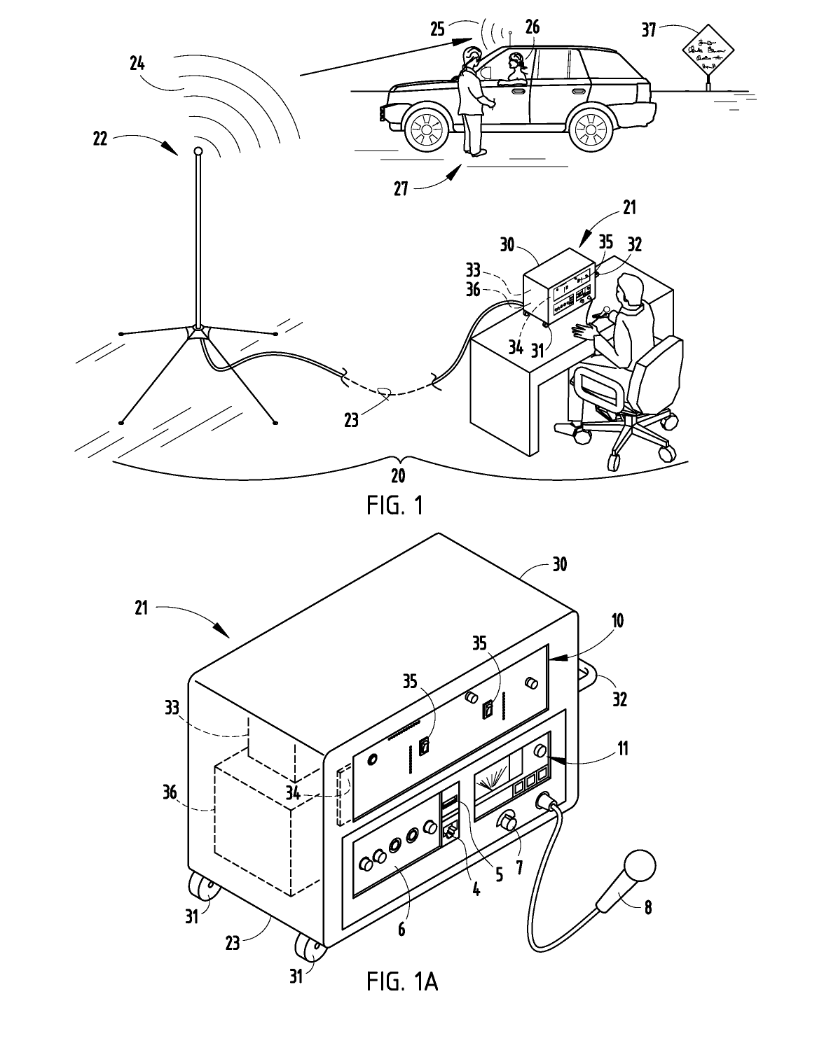

The present portable communication system/apparatus 20 (FIG. 1) (trademarked RadioSTAT™ Portable Emergency Advisory Radio Station”) includes a portable AM transmitter assembly 21 and antenna system 22 operably connected by cable 23, for broadcasting an AM signal 24 to a vehicle's standard radio receiver system 25. By this method, a person 26 riding within the vehicle can be given instructions concerning how to receive medical attention from medical personnel 27 while remaining in their vehicle. The present system 20 is portable and generates an AM radio signal, such that most modern vehicles can pick up the signal once told which frequency to tune in to (such as by a special road sign 37). Further, the system is particularly constructed for mobility, durability, simplicity and ease of use, making it well adapted for use in community and emergency situations. For example, the entire present assembly 20 can be constructed with a total weight of about 130 lbs.

The transmitter assembly 21 includes a wheeled cabinet 30 with wheels 31 and a handle 32 for manual rolling transport. The assembly 21 weighs only about 68 pounds such that it can be readily manually lifted and carried by a single individual. A portable AM transmitter 10 is housed within the cabinet, and is connected to a circuit 34 with controls 35 located inside and outside the cabinet for easy access and use. A digital audio file player 6 is connected to the circuit and includes a database of pre-recorded selectable messages and/or connectors for connecting to an exterior source of messages, such as a USB port, a connector for connecting to a device with digital audio files (i.e. a USB flash drive), an Ethernet port for direct connection to local area network (LAN) or a laptop computer containing digital audio files or in other iterations a dial-up connection (e.g., a cell phone, dialed-up telephone line) or two-way radio receiver.

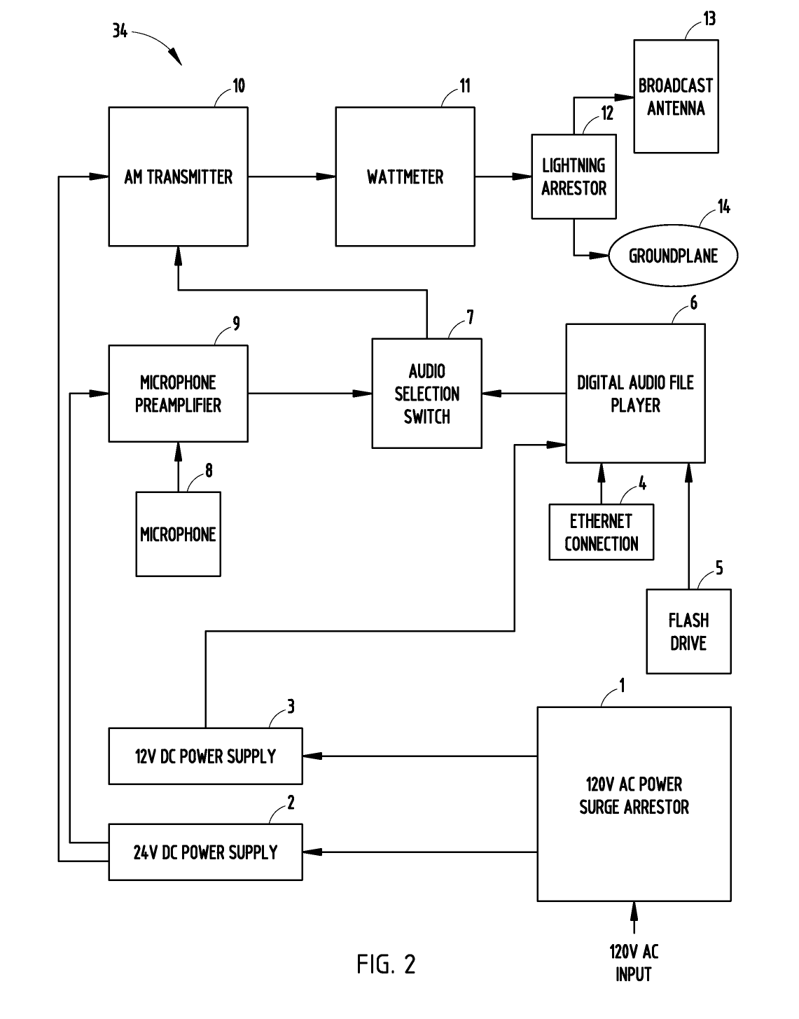

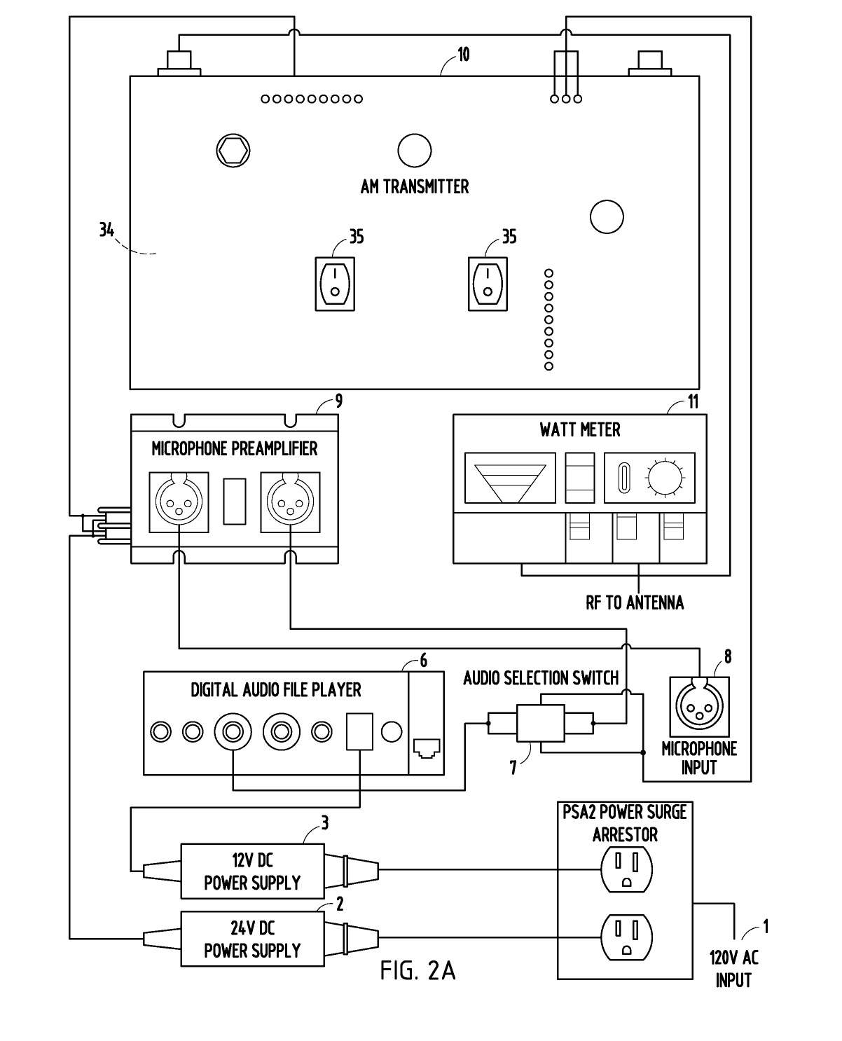

The illustrated circuit shown in FIGS. 2-2A includes a power source such as a 120v AC Input 1 (or battery if so adapted) which supplies power to a 24v DC power supply 2 and a 12v DC power supply 3. The power supply 3 is connected to a digital audio file player 6 with Ethernet connection 4 and input for USB flash drives 5. The digital audio file player 6 is operably connected to an audio selection switch 7. A microphone preamplifier 9 with microphone 8 is also connected to the switch 7. An AM transmitter 10 is connected to an output of the switch 7. By selectively moving the switch 7, an operator can choose between sending live messages (i.e., by using the microphone 8) or select the digital audio file player 6 which provides a continuous stream of prerecorded selectable messages to AM transmitter 10. The AM transmitter 10 is connected to and powered by the power supply 2. An output of the AM transmitter 10 is connected through a watt meter 11 to a lightning arrestor 12, which uses a broadcast antenna 13 and a ground plane 14 to generate an AM signal. The AM signal can be picked up by any standard radio receiver in a vehicle 25 by tuning to the frequency of the particular transmission being broadcast.

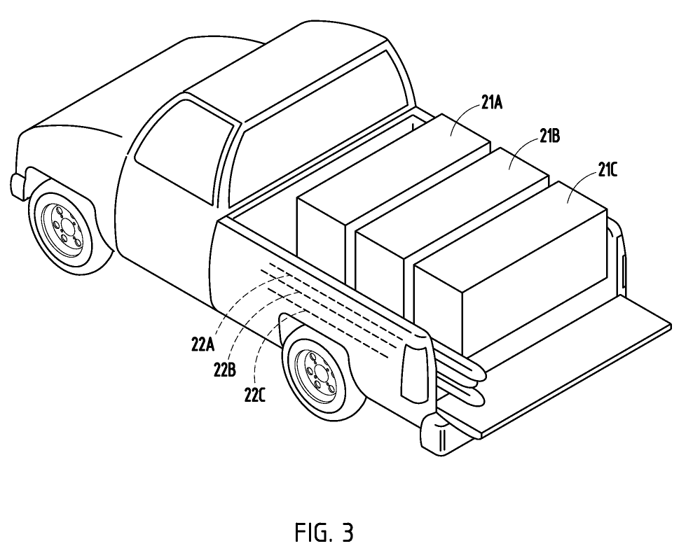

FIG. 3 illustrates that the present system/apparatus 20 is very portable and compact, such that several units (three being illustrated) can be loaded into a vehicle's truck bed (or other light-capacity vehicle such as a boat or air plane) and transported to selected sites. FIG. 3 illustrates a scenario where three apparatus 20 (each including a transmitter assembly 21 and antenna assembly 22) are dropped off at first, second, and third hospitals or points of vaccine inoculation. For example, in a public emergency such as a tornado, patients can be triaged and sent to different locations, such as by sending burn victims to one hospital, persons with broken bones and internal injuries to another hospital, and persons with head trauma to a third hospital. The broadcast messages of the different systems are coordinated with each other, and assist in coordinating patients' arrival at specific locations efficiently. Additional systems 20 could be set up at the location of the accident/catastrophe, and/or at key road/intersection locations to inform incoming citizens, volunteers or the press of important instructions and advisories.

As shown in FIG. 1, during public health and safety emergencies, the apparatus 20 is placed into critical areas and the system operator speaks directly to citizens 26 (while they remain in their vehicles) via standard in-car radio receivers. The critical instructions and information can concern Disasters/Evacuations, Medical Emergencies (hospital surge, points of distribution field information, quarantine isolation, decontamination), Terrorist/Shooter Incidents, HAZMAT and Traffic Information, Critical Public Safety Instructions, Road Construction/Infrastructure Failures, AMBER Alerts, and other community and emergency situations. The RadioSTAT™ system 20 is built for speed and portability. All electronics are housed in an easy-to-transport, high-impact, weather-resistant case. The quick-erect antenna system folds down for transportability. The entire system 20 may be set up in 10 minutes by one person, and even 5 minutes under optimal circumstances with trained personnel.

RadioSTAT™ system 20 broadcasts may be received on standard vehicle radio receivers over a 3-5 mile range (25-75 square miles), and can be deployed simultaneously at different locations during an emergency, if required. Each RadioSTAT™ apparatus 20 can broadcast a select series of messages from a prerecorded library. Notably, because it may be licensed in either a fixed-point and/or within a territory (or both) and therefore has the capability to allow the licensee to move the radio stations to reach the required geography/audience in an emergency, grant money from the US Department of Homeland Security is often obtained for the purchase of TIS stations. Alternatively, as situations change, new messages may be recorded on the spot. Audio software is provided for message creation, editing, processing and archiving on a field laptop or desktop PC. Messages may be staged on USB flash drives 5 for quick deployment. “Live” programming may be placed on the air immediately with the flip of switch 7. RadioSTAT™ systems are FCC-licensed and one or more RadioSTAT™ systems can be operated within a specified territory such as a city, county or state. The signal is typically announced to the public by portable signs 37, positioned at the periphery of the signal coverage area.

During non-emergency times, the RadioSTAT™ system operators typically establish the broadcast on an ongoing basis at a “home location” using a (optional) fixed antenna. Thus, the system can be used during non-emergency times as well as during emergencies, which is a great advantage for community entities. If the home location ever requires evacuation, RadioSTAT™'s portability becomes an instant asset, allowing reestablishment of the signal from the new location quickly.

RadioSTAT™ system's portability makes it especially useful at large public gatherings. broadcasting key information, such as: schedules, traffic, parking, safety and critical instructions for patrons approaching or exiting. It may be called into action at the event or gathering should an emergency occur and/or the event would require an efficient evacuation.

The system/apparatus 20 includes: a transmitter assembly 21 with digital audio file player 6 in portable shock case 30 containing power supplies (2, 3), wattmeter 11, broadcast controls 35 and circuitry 34.
Portable Antenna System & Stand 22 with Coaxial Cable 23 & Stabilizing Sand Bags.
Audio Management Software, Recording Headset/Mic.
6 USB flash Drives in Carrying Case.
Live Microphone 8/Cable.
Equipment Pouches & Stowing Bags for Mics, Cables & Antennas.
Customizable Equipment Management Tags.
Optional Fixed Antenna System—REMOVE
Signs 37 to Notify Motorists to Tune In.
Additional Copies of Audio Management Software.
Additional Recording Headset/Mic.

Optionally, the antenna system may be configured for difficult regions, such as by using an antenna height extender for terrain/interference/obstruction-challenged areas. In addition, the present antenna system can be engineered to and compliant with ANSI/TIA-222-G-2005 (Class III, Category 4, Exposure D) standards. This means it is rated to perform in worst-case environments, such as, unobstructed shorelines in hurricane-prone areas and atop ridges in terrain where wind speeds can achieve great force. Additionally, it is rated for essential communications in critical areas where failure of a structure could damage buildings or present a hazard to life. To achieve these designations, the antenna has to be able to sustain 130 mph/3-second gust winds without failure.

New messages may be sent to the station/apparatus 20 for broadcast either directly by Ethernet network or USB flash drive, telephone (for in telephone-managed systems) or two-way radio. Messages may be sent to the operator as email attachments for transfer to the operator's hard drive or USB flash drive for subsequent sending to the station for broadcast. Messages may be stored off site on data storage devices such as hard drives, USB flash drives or tape for additional security and editing convenience.

### Broadcast Control Electronics

Transmitter 10
0-10-watt operation, Class D, high efficiency output; internal components rated to 3 times operating wattage, utilizing 2 output devices.
Federal Communications Commission certified for Travelers Information Service in the United States under Part 90.242, Certification Number B7MTR-6000TIS-W13.
Approved for US Military use.
Single-hoard design with all RF, power and audio circuitry.
Integral LED wattage and VU reference meters.
Remote broadcast monitoring control.
Synthesized frequency selection, compander-style audio processing.
Defeat-able LED operation to save power.
24v DC, fully regulated power supply.
530 to 1700 kHz AM frequency range.
Frequency stability +/−20 Hz.
Continuously adjustable power and audio modulation controls, externally accessible on front panel.
Tune-able series filter on RF output.
Audio distortion: less than 1.2%, 100 Hz to 3 kHz.
Noise level: 70 dB below 95% modulation level, 100 Hz to 3 kHz.
Modulation: 99%, −40 dB to +20 dB.
Temperature: −40 to +85 degrees Celsius.
Humidity: 95% (non-condensing).
External audio, power and synchronization inputs.
External PL-259 UHF style RF output and ¼″ audio headphone output driven by detector circuit to provide positive modulation indication.
Rack, panel or shelf-mountable cabinet.
Slim-line design (7.5 inches high by 17 inches wide by 1.5 inches deep) and 4 pounds.
Mean time between failure: in excess of 60 years.
Estimated product life: in excess of 30 years.
Power surge arrestor: high speed, high capacity.
IPC-610 certified.
Manufactured in compliance with Class-3 wave solder standards.

Test Equipment
Watt meter and dummy load for antenna tuning and system diagnosis.

IP76 Digital Audio File Player
Local (USB Flash drive) and remote (LAN/WAN) operation.
Digital audio file loading: Removable USB flash drives; built in GUI for uploading to internal memory via Ethernet protocol.
DHCP enabled
6 USB flash drives, 2 GB each, provided.
Audio File format: MP3.
Memory storage: internal 25 MB.
LCD Display for status and IP configuration.
Compatibility: Microsoft Windows computer operating system.
Recording time: 2,000 minutes per USB flash drive.
Up to 1,023 digital audio files using a USB flash drive, auto rotation.
Single digital audio file play repetition using internal memory.
Digital audio file size: variable.
Digital audio file play order: sequential based on file order.
Memory format: “Flash”—no battery backup required.
Audio outputs: 8 or 600 ohms.
Auto reboot on power outage.
Power: 12v DC.

Live Microphone
Shure vocal microphone, 20-foot cable, XLR connectors.
Live mic jack/switch.

Portable Shock Case
Shock and Mil-spec certified waterproof.
Indoor or outdoor use.
Weather-resistant power and coaxial ports.
Key lockable.
Low-profile, retractable pull handle.
Built-in wheels.
Gasket-protected front and rear doors.
Snap-down, trigger latches.
Electronics pre-installed, rack mounted (front).
Internal black Cordura Nylon microphone/cable/USB flash drive pouches (rear).
External AC and coaxial connectors.
Size: 28.25″ wide 23″ high by 30.5″ deep with doors on; or 21″ deep with doors off; 68 pounds.

Computer Software & Headset

Audio Control Software
Powerful audio development software for the creation of audio files. Includes sample-accurate tools to cut, copy, paste, fade, and stretch audio assets. Intuitive on-clip tools make common edits instant, and visual feedback keeps the user informed at every step.
system requirements for customer-provided PC or laptop:
   Intel Pentium 4 (1.4 GHz for DV, 3.4 GHz for HDV); Intel Centrino; Intel Xeon (dual Xeon 2.8 GHz processors for HD); or Intel Core Dueo or compatible processor (SSE2-enabled processor required for AMD systems).
   Microsoft Windows XP Pro or Home Edition with Service Pack 2 or Windows Vista Home Premium, Business, Ultimate, or Enterprise (certified support for 32-bit editions only).
   512 MB of RAM (1 GB for DV playback, 2 GB for HDV and HD playback).
   10 GB of available hard-disk space (when used with Loopology DVD). DVD drive.
   1280 by 900 monitor resolution with 32-bit video card and 16 MB of VRAM.
   Microsoft DirectX or ASIO compatible sound card.

Mic/Headset for recording.
USB behind-the-head stereo headset, compatible with Windows and Macintosh.
   Speaker driver size: 36 mm diameter.
   Speaker frequency response: 20 Hz-20 kHz.
   Microphone frequency response: 100 Hz to 8 kHz.
   Cable length: 9.5 feet (3.5 mm plugs).
   Plug into sound card.

### Antenna and Grounding System

Antenna
Whip-style antenna, between 15 and 25 feet long; maximum 2.0-inch OD, tapering to 0.5 inch.
Aluminum construction, black finish color to discourage ice buildup; UV resistant finish; architectural anodization process #801.
Stainless-steel tuning tip and assembly hardware.
Wind rating: Antennas 1230 kHz and above 100 MPH; 80 MPH with ¼ radial ice; antennas 1220 kHz and below 80 MPH; 50 MPH with ¼ radial ice.
Total antenna system weight: 18-20 pounds depending upon antenna needed for frequency.
Stowed size: 1-by-1-by-6-foot area.

Antenna Stand and Arrestor
Antenna stand: folding, quick-erect, aluminum; 26 pounds, 65 by 11 by 9 inches.
Rated for 70 MPH wind gusts.
Antenna mounts and hardware.
4 empty sandbags for weighting the antenna stand.
Integrated RF surge arrestor:
   Capacity: 50,000-amps surge.
   Clamping speed: fewer than 2.5 nS.
   2 UHF connectors.
   Aluminum flange ground connection.

Ground plane
Patented, factory-assembled, flexible antenna ground plane (30 elements, 10-foot radius).

Coaxial Cable
2 sections, 50 feet each, 50 ohm with joining connector.

Carrying Sleeves
2 black Cordura Nylon carrying bags with straps: 1 for antenna, 1 for coaxial cable and ground plane.

Setup Tools
Includes 10-inch crescent wrench, 12-inch crescent wrench, ⅛-inch hex wrench, 7/16-nut driver, slotted screwdriver.

### Other System Details

Overall Station Specifics
Weight: Approximately 120 pounds.
Utilities Required: 110-volt AC, single-phase/50/60 Hz, less than 1 amp AC operating current (20A breaker).
Training Materials

System Options
Additional USB flash drives.
Additional computer mic/headphones.
Additional audio management software.
Vertical profile antenna system (for fixed-location operation).
Antenna height extender to increase signal strength 70%, useful for areas challenged by terrain, interference or obstruction.

Companion Product
FASTRACK Quick-Erect, Portable Signs (for announcing the signal to motorists).

The present apparatus 20 can advantageously be licensed as a Travelers Information Station under FCC Rules Part 90.242 at—for example—1610 KHz AM. Further, the entire system can be made to occupy less than 6 square feet of floor space when in storage or in transit to the broadcast location. The one-piece lightweight (aluminum) portable antenna stand (with integral antenna mounts, lightning arrestor, portable ground plane, and ground bus) is designed to operate in high wind conditions. The stand with attached antenna and ground plane may be placed on a rooftop or on the ground, and the folding legs weighted with sand bags (provided) for stability. The legs of the stand become part of the ground plane of the antenna system. The variable-length, deployable coaxial cable allows the transmitter in the portable case and antenna system to be installed in locations separated by as much as 100 feet to accommodate the variations in broadcasting sites. The case is built for portability, including built-in pull handle & wheels for rolling transport—and handles for two-sided lifting by one or two people. The case is ATA specification 300—Category 1 rated, and includes lockable TSA latches and includes rubber shock-mounts, weatherproof gasketed doors, and weatherproof ports for AC or DC power and Coaxial Antenna Cable. Inside are custom pouches for stowing microphones, cables, USB flash drives and other equipment used in the function of the system. Though typically operated via AC power from landline or generator, RadioSTAT™ apparatus 20 may be optioned to operate on DC 24v power, or, with the addition of a DC to AC power inverter, any DC voltage may be utilized to power the system. Integral to the portable case is an inline watt meter for confirming transmitter operation and diagnosing antenna performance as well as a dummy load, which may be used in conjunction with the wattmeter to monitor the integrity of the coaxial cable and connectors, as well as verifying the transmitter's RF output level.

When using the present system 20, the operator has the ability to broadcast live or pre-recorded messages to motorists with standard automobile radio receivers, who the broadcaster can see and therefore can tailor the messages to address. Further, messages may be uploaded to the RadioSTAT™ unit/system as digital audio files over an Ethernet network utilizing standard network protocol or USB ports located within the RadioSTAT™ electronics case using a USB flash drive containing messages as digital audio files. In other iterations, messages may also be loaded via dialed-up telephone line, cell phone and/or two-way radio transceiver. Thus, TIS broadcast messages can be transferred to RadioSTAT by email, USB flash drive or Ethernet network. In the case of the Ethernet network method, the messages may be automatically downloaded from a FTP site. TIS broadcast messages can be professionally produced by the licensee, his agent, the equipment manufacturer or others, since a standard file format is utilized such as mp3.

The RadioSTAT™ system is sufficiently durable and long lasting such that it can be used portably as well as at a fixed location, thus allowing “bonus” use by a community during non-emergency periods (i.e. when the portable use is not required.)

The system 20 can be advantageously used in unique emergency and medical applications, such as:
Directing motorists to which hospital to visit based on their physical condition;
To inform motorists regarding directions and procedures during mass inoculation
Based on real time instruction given by the RadioSTAT™'s operator broadcasting live, a motorist can maneuver to a particular location in a hospital parking lot, allowing a patient to receive treatment in their vehicle so that they do not need to enter the hospital. This assists in both patient-flow efficiency and/or hospital personnel isolation.
Prior to or in the aftermath of disasters, to inform the public regarding emergency services, evacuation routes or official announcements or public safety orders.
In association with public events, to inform patrons in their automobiles of traffic status, directions, how to exit the event efficiently upon its conclusion and what actions to take should an emergency occur during the event.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A manually-movable portable system for giving community emergency information or travelers information, comprising:
a portable wheelable cabinet with a handle for manual rolling-or-carried transport to sites of use;
a portable transmitter housed in the cabinet and adapted to broadcast radio signals that can be received by a standard radio receiver in a passenger vehicle;
a portable antenna operably connected to the transmitter;
a control circuit connected to the transmitter, the control circuit including externally-accessible controls on at least one side of the cabinet and a digital audio file player for providing an audio program to the transmitter;
a database of pre-recorded selectable messages that can be accessed and selectively sent from the digital audio file player to the transmitter for broadcast;
a microphone for receiving a live spoken message operably connected to the control circuit; and
the controls including a switch for switching between the pre-recorded messages and the microphone, whereby the system can be operated to transmit any one of the pre-recorded selectable messages as well as to transmit a specific real-time spoken instruction to passengers of the passenger vehicles thru standard automobile radio receivers by an operator watching the passenger vehicle when the passenger vehicle enters a critical space.

2. The portable system defined in claim 1, wherein the transmitter operates at 1610 KHz under a frequency of a travel information station.

3. The portable system defined in claim 1, wherein the control circuit includes an FTP site connection for receiving pre-recorded messages to later transmit.

4. The portable system defined in claim 1, wherein the control circuit includes connections for receiving pre-recorded messages to later transmit.

5. A method of giving community emergency information or travelers information, comprising steps of:
providing a portable transmitter system and portable antenna system adapted to communicate to standard radio receivers within passenger vehicles;
transmitting selected pre-recorded messages on the transmitter system to communicate directly with passengers in the passenger vehicles, the pre-recorded messages including information about particular assistance sites to drive to for help with particular emergencies;
watching the passenger vehicles as the passenger vehicles arrive at a particular assistance site; and
switching to provide a live instruction to passengers in the passenger vehicles to control activity of the passengers and/or to control a flow of the passenger vehicles at the particular assistance site.

6. The method defined in claim 5, wherein the step of providing includes providing a complete and portable radio station, and including a step of repeatedly moving the radio station to service people within a particular geographic area.

7. The method defined in claim 5, wherein the step of transmitting selected pre-recorded messages includes transmitting messages concerning homeland security.

8. The method defined in claim 5, wherein the step of transmitting selected pre-recorded messages includes transmitting messages concerning mass medical treatment.

9. The method defined in claim 5, wherein the step of transmitting selected pre-recorded messages includes downloading prerecorded messages from an FTP site.

10. The method defined in claim 5, wherein the step of transmitting selected pre-recorded messages includes downloading messages.

11. The method defined in claim 5, wherein the step of transmitting selected pre-recorded messages includes transmitting at 1610 KHz.

12. A method of coordinating community emergency health treatment, comprising steps of:
providing a portable transmitter and portable antenna adapted to communicate to standard radio receivers within passenger vehicles; and
transmitting selected messages on the transmitter to communicate directly with passengers in the passenger vehicles, the messages including instructions to the passengers asking for the passengers to extend their arm from a vehicle window for inspection and/or treatment as the vehicle passes one or more points of medical information-gathering, diagnosis and treatment, whereby health emergencies, such as flu and/or contagious epidemics, can be safely handled while still providing mass medical treatment in an efficient manner.

13. A method for giving community emergency information, comprising steps of:
providing a plurality of at least three hand-portable cabinets each with a handle for manual transport to sites of use, a portable transmitter system housed in the cabinet and adapted to broadcast radio signals that can be received by a standard radio receiver in a passenger vehicle, and a portable antenna system adapted to operably connect to the transmitter system; the cabinets further each further including a control circuit connected to the transmitter system, the control circuit including controls on an outside of the cabinet and a digital audio file player for providing audio to the transmitter system, a database of pre-recorded selectable messages that can be accessed and selectively sent to the transmitter system for broadcast by the digital audio file player, a microphone for receiving a live spoken message operably connected to the control circuit, and a switch for switching from transmitting the pre-recorded messages to the microphone;
placing the at least three hand-portable cabinets and associated antenna systems in a truck;
dropping off the at least three hand-portable cabinets at different strategic locations;
activating each of the transmitter system to transmit selected messages; and
manually operating at least one of the transmitter systems to periodically transmit a specific real-time spoken instruction to a standard radio receiver being monitored by passengers of the passenger vehicles by an operator watching the passenger vehicle when the passenger vehicle enters a critical space.

14. The method defined in claim 13, including a step of manually moving the cabinets with transmitter systems.

15. The method defined in claim 14, wherein the cabinets include wheels and a handle, and wherein the step of manually moving the cabinets includes grasping and pulling the handle to roll one of the cabinets on the wheels of the one cabinet.
